(19) United States
(12) Patent Application Publication
(10) Pub. No.: US 2008/0008845 A1
(43) Pub. Date: Jan. 10, 2008

(54) Light diffusion sheet for a display device

(76) Inventors: Young Oh, Namdong-gu (KR); Chang Hee Cho, Gunpo-si (KR); Seung Man Choi, Bucheon-si (KR)

Correspondence Address: LEE & MORSE, P.C., 3141 FAIRVIEW PARK DRIVE, SUITE 500, FALLS CHURCH, VA, 22042, US

(21) Appl. No.: 11/822,049

(22) Filed: Jul. 2, 2007

(30) Foreign Application Priority Data
Jul. 7, 2006 (KR) 10-2006-0064065
Dec. 5, 2006 (KR) 10-2006-0122521

(51) Int. Cl. B32B 27/28; B32B 27/08; B32B 3/00

(52) U.S. Cl. 428/1.3; 428/174; 428/332; 428/339; 428/476.3; 428/483; 428/500

(57) ABSTRACT

A light diffusion sheet for a display device includes a base layer having a base resin mixture of a methacrylate-styrene copolymer and a methylmethacrylate-styrene copolymer and about 0.2 to 20 ppwb of a first light diffuser, and at least one coating layer on the base layer, the coating layer including a methylmethacrylate-styrene copolymer base coating resin, about 0.1 to 30 ppwb of a second light diffuser, about 0.01 to 2 ppwb of an UV absorber, and about 0.001 to 10 ppwb of an antistatic agent.

### BACKGROUND OF THE INVENTION

1. Field of the Invention

Embodiments of the present invention relate to a light diffusion sheet for a display device. More specifically, embodiments of the present invention relate to a light diffusion sheet of a liquid crystal display having improved light resistance, optical efficiency, and diffusibility.

2. Description of the Related Art

In general, liquid crystal displays (LCDs) refer to flat panel displays capable of displaying images by applying electric field to a liquid crystal between two substrates, and controlling the amount of light transmitted from an external light source, i.e., a backlight unit (BLU), through the substrates by controlling the intensity of the electric field. Accordingly, a conventional LCD may have a BLU on a rear surface thereof.

A conventional BLU may be either an edge type BLU, i.e., a BLU employed in thin monitors, e.g., a monitor for a notebook or a desktop computer, or a direct type BLU, i.e., a BLU employed in large-sized devices, e.g., an LCD TV. The conventional direct type BLU may include a light source capable of emitting perpendicular light toward a LCD panel through at least one reflection sheet and a light diffusion sheet. The light diffusion sheet may scatter the light emitted from the light source in order to provide uniform light distribution throughout the LCD panel. The conventional light diffusion sheet may include a light diffuser on a transparent thermoplastic base film, e.g., methacrylic, styrene, cycloolefin, or polycarbonate resins.

However, when the BLU is employed in, e.g., large-sized LCD TVs, the amount of light emitted from the light source may be increased to provide sufficient brightness. An increased amount of light may substantially enhance the amount of heat in the BLU, thereby distorting the light diffusion sheet. More specifically, the conventional base resins, e.g., methacrylic and styrene resins, used to form the transparent base film in the conventional light diffusion sheet may be deformed due to excessive heat generated by the BLU light source, thereby distorting display properties of the LCD panel. Accordingly, there exists a need for a light diffusion sheet capable of withstanding high heat, while exhibiting sufficient optical properties and formability.

### SUMMARY OF THE INVENTION

Embodiments of the present invention are therefore directed to a light diffusion sheet, which substantially overcomes one or more of the disadvantages of the related art.

It is therefore a feature of an embodiment of the present invention to provide a light diffusion sheet with enhanced light resistance for a display device.

At least one of the above and other features and advantages of the present invention may be realized by providing a light diffusion sheet for a display device, including a base layer including a base resin mixture of a methacrylate-styrene copolymer and a methylmethacrylate-styrene copolymer and about 0.2 ppwb to about 20 ppwb of a first light diffuser, and at least one coating layer on the base layer, the coating layer including a methylmethacrylate-styrene copolymer base coating resin, about 0.1 ppwb to about 30 ppwb of a second light diffuser, about 0.01 ppwb to about 2 ppwb of an UV absorber, and about 0.001 ppwb to about 10 ppwb of an antistatic agent. The base layer may have a thickness of about 100 μm to about 10,000 μm. The coating layer may have a thickness of about 10 μm to about 1,000 μm

The methacrylate-styrene copolymer of the base layer may include about 2% to about 20% by weight of a methacrylate monomer and about 80% to about 98% by weight of a styrene monomer. The methylmethacrylate-styrene copolymer of the base layer may include about 6% to about 94% by weight of a methylmethacrylate monomer and about 6% to about 94% by weight of a styrene monomer. The first light diffuser of the base layer may include about 0.1 ppwb to about 10 ppwb of a siloxane component having an average diameter of about 1 μm to about 20 μm and about 0.1 ppwb to about 10 ppwb of an acrylic component having an average diameter of about 1 μm to about 20 μm.

The second light diffuser of the coating layer may include an acrylic component having an average diameter of about 1 μm to about 50 μm, a siloxane component having an average diameter of about 1 μm to about 20 μm, or a combination thereof. The siloxane component may include one or more of a polydimethylsiloxane, a polydiethylsiloxane, and/or a silicone resin having a three dimensional network structure. The acrylic component may include one or more of a methyl methacrylate, ethyl methacrylate, butyl methacrylate, cyclohexyl methacrylate, phenyl methacrylate, benzyl methacrylate, methyl acrylate, ethyl acrylate, butyl acrylate, cyclohexyl acrylate, phenyl acrylate and/or benzyl acrylate.

The UV absorber of the coating layer may absorb UV radiation of about 250 nm to about 280 nm. The UV absorber may include one or more of a benzophenone, a benzotriazole, a cyanoacrylate, and/or a nickel complex salt. The antistatic agent of the coating layer may include one or more of a polyether imide amide, a polyether ester, a polyether ester amide, a polyalkylene glycol, an alkali metal dodecylbenzene sulfonate, a tertiary amine, a quaternary ammonium, sodium chloride, and/or an alkyl amine. The coating layer may further include blowing agents, plasticizers, antioxidants, thermal stabilizers, lubricants, flame retardants, fillers, release agents, dyes, pigments, anti-dropping agents, nucleating agents, light stabilizers, and/or a combination thereof.

The coating layer may include an embossing pattern. The embossing pattern may be amorphous, and may have a surface roughness of about 0.1 μm to about 20 μm. The coating layer may further include a light stabilizer. The light diffusion sheet may include two coating layers. The base layer may be between the two coating layers.

At least one of the above and other features and advantages of the present invention may be also realized by providing a BLU, including a light source, at least one reflection sheet, and a light diffusion sheet, the light diffusion sheet having a base layer with a base resin mixture of a methacrylate-styrene copolymer and a methylmethacrylate-styrene copolymer and about 0.2 ppwb to about 20 ppwb of a first light diffuser, and at least one coating layer on the base layer, the coating layer having a methylmethacrylate-styrene copolymer base coating resin, about 0.1 ppwb to about 30 ppwb of a second light diffuser, about 0.01 ppwb to about 2 ppwb of an UV absorber, and about 0.001 ppwb to about 10 ppwb of an antistatic agent.

At least one of the above and other features and advantages of the present invention may be further realized by providing a display device, including a display panel, and a BLU with a light source, the BLU having a light diffusion sheet with a base layer including a base resin mixture of a methacrylate-styrene copolymer and a methylmethacrylate-styrene copolymer and about 0.2 ppwb to about 20 ppwb of a first light diffuser, and at least one coating layer on the base layer, the coating layer including a methylmethacrylate-styrene copolymer base coating resin, about 0.1 ppwb to about 30 ppwb of a second light diffuser, about 0.01 ppwb to about 2 ppwb of an UV absorber, and about 0.001 ppwb to about 10 ppwb of an antistatic agent. The display device may be a liquid crystal display.

### BRIEF DESCRIPTION OF THE DRAWINGS

The above and other features, features and other advantages of the present invention will be become more apparent to those of ordinary skill in the art by describing in detail exemplary embodiments thereof with reference to the attached drawings, in which:

FIG. 1 illustrates a perspective view of a light diffusion sheet according to an embodiment of the present invention;

FIG. 2 illustrates a perspective view of a light diffusion sheet according to another embodiment of the present invention; and

FIGS. 3A-3B illustrate schematic cross-sectional views of back light units having the light diffusion sheets of FIGS. 1-2, respectively.

FIGS. 4A-4B illustrate perspective exploded views of display devices having the light diffusion sheets of FIGS. 1-2, respectively.

### DETAILED DESCRIPTION OF THE INVENTION

Korean Patent Application Nos. 10-2006-0064065 and 10-2006-0122521, filed on Jul. 7, 2006, and on Dec. 5, 2006, respectively, in the Korean Intellectual Property Office, and entitled “Light Diffusion Sheet for LCD Back Light Unit,” are incorporated by reference herein in their entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

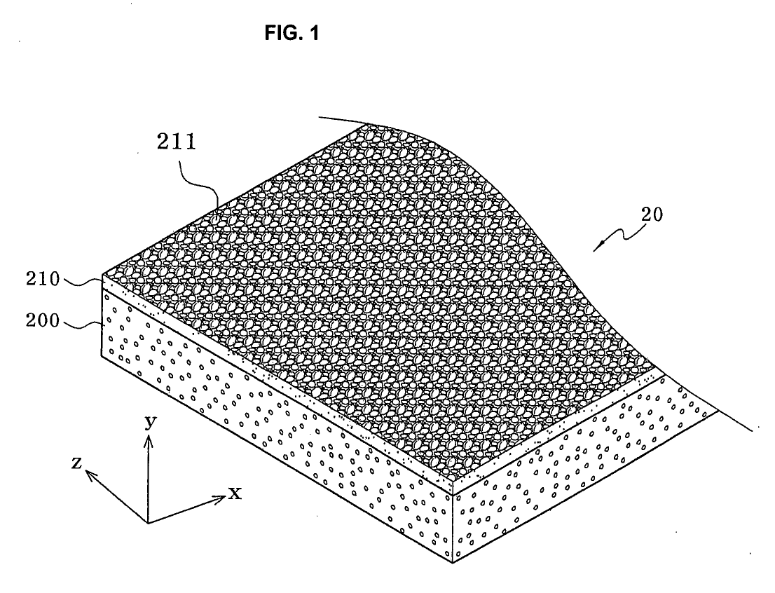

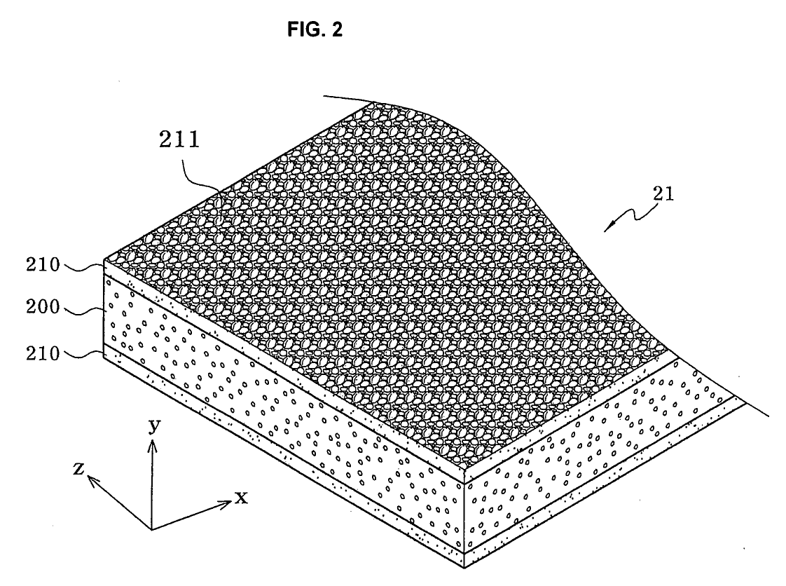

An exemplary embodiment of a light diffusion sheet for a display panel, e.g., a liquid crystal display (LCD), according to the present invention will be described in more detail below with respect to FIGS. 1-2. As illustrated in FIG. 1, a light diffusion sheet 20 may include a base layer 200 and at least one coating layer 210 on the base layer 200.

The base layer 200 of the light diffusion sheet 20 may function as a supporting base of the light diffusion sheet 20 upon application to a display device (not shown), and may have a thickness of about 100 to about 10,000 μm, i.e., a distance as measured along the y-axis. The base layer 200 may include about 100 parts by weight of a base resin mixture and about 0.2 ppwb to about 20 ppwb of a light diffuser having an average diameter of about 1 μm to about 20 μm. In this respect, it should be noted that weight components are indicated with respect to the weight of the base resin mixture of the base layer 200 or a base coating resin of the coating layer 210, i.e., weights are calculated as “parts by weight per 100 parts by weight of the base resin” or “ppwb.” More specifically, weight components of the base layer 200 expressed in terms of “ppwb” are indicated with respect to the base resin mixture of the base layer 200. Weight components of the coating layer 210 expressed in terms of “ppwb” are indicated with respect to the base coating resin of the coating layer 210, as will be discussed in more detail below.

More specifically, the base layer 200 may include a base resin mixture having a methacrylate-styrene copolymer and a methylmethacrylate-styrene copolymer. The methacrylate-styrene and methylmethacrylate-styrene copolymers may be mixed by suitable techniques, such as, e.g., emulsion polymerization, suspension polymerization, solution polymerization, bulk polymerization, and so forth.

The methacrylate-styrene copolymer may include about 2% to about 20% by weight of a methacrylate monomer and about 80% to about 98% by weight of a styrene monomer. Preferably, the methacrylate-styrene copolymer may include about 5% to about 10% by weight of a methacrylate monomer and about 90% to about 95% by weight of a styrene monomer. The methacrylate-styrene copolymer may have an average molecular weight of about 200,000 to about 350,000 based on standard polystyrene.

The methylmethacrylate-styrene copolymer may include about 6% to about 94% by weight of a methylmethacrylate monomer and about 6% to about 94% by weight of a styrene monomer. Preferably, the methylmethacrylate-styrene copolymer may include about 20% to 80% by weight of a methylmethacrylate monomer and about 20% to about 80% by weight of a styrene monomer. The methylmethacrylate-styrene copolymer may have an average molecular weight of about 70,000 to about 300,000 based on standard polystyrene.

The light diffuser of the base layer 200 may include organic particles, e.g., siloxane, fluorinated polymers such as Teflon®, acrylic and/or styrene, or inorganic particles, e.g., calcium carbonate, barium sulfate, titanium dioxide, aluminum hydroxide, silica, glass, talc, mica, white carbon, magnesium oxide, and/or zinc oxide, dispersed in the base resin mixture, and may exhibit a refractive index difference of about 0.02 to 0.13 with respect to the base resin mixture.

In an implementation, the light diffuser may include about 0.1 ppwb to about 10 ppwb of a siloxane component having an average diameter of about 1 μm to about 20 μm, and about 0.1 ppwb to about 10 ppwb of an acrylic component having an average diameter of about 1 μm to about 20 μm. Examples of the siloxane component may include a cross-linked siloxane resin having spherically-shaped cross-linked particles. The cross-linked siloxane resin may include a silicone resin existing as a solid at room temperature, e.g., a silicone rubber having a low cross-linking degree and a good flowability and a silicone resin having high cross-linking degree and hardness, a polydialkylsiloxane resin, e.g., polydimethylsiloxane and polydiethylsiloxane, a silicone resin having a three dimensional network structure, e.g., an epoxy terminated moiety-containing siloxane, and so forth. Without intending to be bound by theory, it is believed that use of a cross-linked siloxane resin may impart superior weatherability to the light diffuser, so that the light diffuser may exhibit significantly reduced yellowing upon prolonged exposure to a light source.

The siloxane component may have a relatively low refractive index as compared to other organic cross-linked compounds. More specifically, the siloxane component may have a refractive index of about 1.40 to about 1.43. Accordingly, and without intending to be bound by theory, it is believed that even a small amount of the siloxane component may be sufficient to impart optical diffusibility and light transmittance to the light diffusion sheet 20, as compared to other cross-linked organic resins.

Examples of the acrylic component used in the light diffuser of the base layer 200 may include an acrylic monofunctional monomer, such as alkyl acrylate, e.g., ethyl acrylate, methyl acrylate, butyl acrylate, cyclohexyl acrylate, phenyl acrylate, benzyl acrylate; an alkyl methacrylate, e.g., ethyl methacrylate, methyl methacrylate, butyl methacrylate, cyclohexyl methacrylate, phenyl methacrylate, benzyl methacrylate; like monomers; and combinations thereof. The acrylic component may include spherically-shaped cross-linked particles, and may have a refractive index of about 1.46 to about 1.56. In this respect, it should be noted that the refractive index of the acrylic component may be adjusted with a methacrylate or a methacrylate-styrene copolymer, i.e., an increase in a number of phenyl or halogen groups may increase the refractive index.

The base layer 200 of the light diffuser sheet 20 may further include an impact resistance modifier to enhance elastic properties of the base layers 200, e.g., impart high impact resistance and large bending stiffness. The impact resistance modifier may include an elastomer, e.g., acrylic rubber, methacrylic rubber, butadiene rubber, and so forth.

The at least one coating layer 210 of the light diffusion sheet 20 may be formed on the base layer 200, as illustrated in FIG. 1, to a thickness of about 10 μm to about 1,000 μm. The coating layer 210 of the light diffusion sheet 20 may include about 100 parts by weight of a base coating resin, about 0.1 ppwb to about 30 ppwb of a light diffuser having an average diameter of about 1 μm to about 50 μm, about 0.01 ppwb to about 2 ppwb by weight of a ultraviolet (UV) absorber, and about 0.001 ppwb to about 10 ppwb by weight of an antistatic agent. The base coating resin of the coating layer 210 may be different than the base resin mixture of the base layer 200. In particular, the base coating resin of the coating layer 210 may include a methylmethacrylate-styrene copolymer. The methylmethacrylate-styrene copolymer of the base coating resin of the coating layer 210 may be substantially similar to the methylmethacrylate-styrene copolymer of the base resin mixture of the base layer 200, e.g., the methylmethacrylate-styrene copolymer may include about 6% to about 94% by weight of a methylmethacrylate monomer and about 6% to about 94% by weight of a styrene monomer.

The light diffuser of the coating layer 210 may include an acrylic component, a siloxane component, or a combination thereof. In an implementation, the composition of the acrylic and/or siloxane component of the light diffuser of the coating layer 210 may be substantially similar to the composition of the acrylic and/or siloxane components described previously with respect to the base layer 200, and therefore, their detailed composition will not be repeated herein. The average diameter of the acrylic component of the coating layer 210 may be different than the average diameter of the acrylic component of the base film 200, although their refractive indices may be the same. Without intending to be bound by theory, it is believed that the light diffuser of the coating 210 may control whiteness or glossiness of a surface thereof, e.g., an irregularly-shaped surface of the coating layer 210 as will be discussed below, thereby enhancing aesthetic properties thereof, while minimizing or preventing deterioration in optical transmittance and diffusibility.

The UV absorber of the coating layer 210 may shield the diffusion light sheet 20 from UV radiation emitted from the light source. The UV absorber may be any material capable of absorbing light having a wavelength of about 250 nm to about 280 nm. For example, the UV absorber may be one or more of a benzophenone, a benzotriazole, a cyanoacrylate, a salicylate, and a nickel complex salt. A light stabilizer may be added into the UV absorber to minimize free radicals therein, so that overall durability of the base coating resin may be improved. The light stabilizer may be, e.g., a hindered amine capable of minimizing degradation of any of the components of the diffusion light sheet 20.

The antistatic agent of the coating layer 210 may minimize space charges in the coating layer 210. More specifically, the methylmethacrylate-styrene copolymer may have a relatively high specific resistance, i.e., generate static on a surface thereof, so that dust may accumulate and adhere thereto. The dust may deteriorate appearance of the light diffuser sheet 20, reduce the luminance efficiency thereof, and cause lamp discoloration. Accordingly, the antistatic agent of the coating layer 210 may minimize static electricity on a surface thereof, thereby reducing an amount of dust thereon. The antistatic agent may include one or more of an ether imide amide, a polyether ester, a polyether ester amide, a polyalkylene glycol, an alkali metal dodecylbenzene sulfonate, a tertiary amine, a quaternary ammonium, sodium chloride, and/or an alkyl amine.

The light diffuser sheet 20 may further include one or more additives. The additives may include blowing agents, plasticizers, antioxidants, thermal stabilizers, lubricants, flame retardants, fillers, release agents, dyes, pigments, anti-dropping agents, nucleating agents, or a combination thereof. For example, use of a blowing agent in the light diffuser sheet 20 may minimize yellowing of the light diffuser sheet 20 caused by resin degradation.

The coating layer 210 may have at least one irregularly shaped surface. For example, the coating layer 210 may have an amorphous embossing pattern 211 on a surface thereof, so that light transmitted from a light source toward a LCD panel through may be scattered, diffused, or concentrated via the light diffusion sheet 20. In particular, light transmitted through pores of the amorphous embossing pattern 211 of the coating layer 210 may be, e.g., scattered in a plurality of directions, thereby enhancing optical transmittance and diffusibility of the light diffusion sheet 20 and improving overall luminance of the LCD. The amorphous embossing pattern 211 of the coating layer 210 may have a surface roughness of about 0.1 μm to about 20 μm, i.e., an average vertical height variation of irregularities in the surface of the coating layer 210.

The irregularly shaped surface of the coating layer 210 may be formed by, e.g., press processing, UV resin coating and processing, contact processing via a polishing roll, and so forth. For example, the polishing roll may be used to form irregularities on the surface of the coating layer 210, so that uniformly scattered light emitted from the light source toward the LCD, e.g., in a form of bright lines, may be dimmed. The shape of the irregularly shaped surface may depend on, e.g., a distance between light sources, a distance between the light diffusion sheet and the light source, brightness of the light source, and so forth.

The coating layer 210 may be applied to the base layer 200 so that the amorphous embossing pattern 211 thereof may face away from the base layer 200. The base layer 200 and the coating layer 210 may be bonded to each other by a suitable method, such as, e.g., injection molding, extrusion molding, vacuum molding, thermal-press molding, coextrusion molding, film deposition, solvent adhesion, surface coating, lamination, and so forth.

The components of the light diffuser sheet 20 may be mixed by a thermoplastic molding technique, such as, e.g., injection molding, extrusion molding, vacuum molding, thermal-press molding, co-extrusion molding, and like techniques. For example, the multilayer-extrusion molding may be carried out with a polishing roll by mixing components for each of the base layer 200 and the coating layer 210, and feeding each of the mixtures into a feed block die or a multi-manifold die to form a multilayer laminate, i.e., a structure having a plurality of layers stacked along the y-axis. For example, the multilayer laminate may be the light diffuser sheet 20 having a double-layer laminate structure.

According to another embodiment of the present invention, a light diffuser sheet 21 may be similar to the light diffuser sheet 20, with the exception of having a plurality of coating layers 210. For example, one coating layer 210 may be laminated on opposing surface of the base layer 200, as illustrated in FIG. 2. In other words, the base layer 200 may be positioned between at least two coating layers 210. Additionally, other configurations of the base layer 200 and the coating layers 210 are within the scope of the present invention.

According to embodiments of the present invention, the base resin mixture of methacrylate-styrene copolymer and methylmethacrylate-styrene copolymer in the base film 200 may improve heat resistance, light resistance, and optical properties thereof, while the spherically-shaped siloxane and/or acrylic components of the light diffusers may impart superior optical diffusibility and transmittance thereto. Further, use of an organic light diffuser, rather than a conventional inorganic light diffuser, may provide enhanced uniformity of light dispersion, thereby minimizing abrasion and damage of production equipment and reducing particle adhesion. Similarly, the composition of the coating layer 210 according to embodiments of the present invention may substantially minimize yellowing caused by prolonged exposure to light and/or heat, and dust adhesion triggered by static electricity. It should be noted that the antistatic agent and light stabilizer may be incorporated only into the coating layer 210, thereby reducing production costs. Accordingly, a display device, e.g., LCD, formed with a light diffusion sheet according to an embodiment of the present invention may exhibit improved display characteristics, while providing reduced production costs.

The present invention will be better understood from the following examples. These examples are not to be construed as limiting the scope of the invention.

### EXAMPLES

### Example 1

Production of a base layer: methacrylate-styrene (MS) copolymer and methylmethacrylate-styrene (MMS) copolymer were mixed to form 100 parts by weight of a base resin mixture. Silicone particles (available from GE Toshiba Silicone Co., Ltd.) having an average diameter of 2 μm in an amount of 2 ppwb and acrylic crosslinked particles (available from Sekisui Chemical Co., Ltd.) having an average diameter of 8 μm in an amount of 2 ppwb were added to the base resin mixture to form a base layer composition.

Production of a coating layer: a MS copolymer was prepared to form 100 parts by weight of a base coating resin. Acrylic cross-linked particles having an average diameter of 20 μm (available from Sekisui Chemical Co., Ltd.) in an amount of 10 ppwb, an antistatic agent in an amount of 1 ppwb, and a light stabilizer in an amount of 1 ppwb were added to the base coating resin mixture to form a coating layer composition.

Production of a multilayer light diffusion sheet: each of the base layer composition and the coating layer composition was injected into an extruder, followed by melting and milling. Next, each of the base layer composition and the coating layer composition was fed into a feed block die to be laminated to each other to form a multilayer light diffusion sheet having a triple layer laminate structure having a base layer between two coating layers. Each of the coating layers was measured to have a thickness of 100 μm. The base layer was measured to have a thickness of 1,800 μm.

### Comparative Example 1

a multilayer light diffusion sheet was produced according to the process of Example 1, with the exception of using a polystyrene (PS) resin (available from PS Japan Corp.) as a base coating layer resin.

### Comparative Example 2

a multilayer light diffusion sheet was produced according to the process of Comparative Example 1, with the exception of using a polymethylmethacrylate (PMMA) resin (available from Mitsubishi Rayon Corp.) as a base layer resin.

### Comparative Example 3

a multilayer light diffusion sheet was produced according to the process of Comparative Example 1, with the exception of using a PS resin (available from PS Japan Corp.) as a base layer resin.

Compositions of each of the base layer mixtures and base coating layers of Example 1 and Comparative Examples 1-3 are summarized in Table 1 below.

TABLE 1
Sample Compositions

| | | | | | Com. |
|---|---|---|---|---|---|
| | | Ex. 1 | Com. Ex. 1 | Com. Ex. 2 | Ex. 3 |
| Base | Base Resin | MS/MMS | MS/MMS | PMMA | PS |
| layer | Mixture | | | | |
| | silicone light | 2 | 2 | 2 | 2 |
| | diffuser (ppwb) | | | | |
| | acrylic | 2 | 2 | 2 | 2 |
| | component | | | | |
| | (ppwb) | | | | |
| Coating | Base Coating | MS | PS | PS | PS |
| layer | Resin | | | | |
| | acrylic | 10 | 10 | 10 | 10 |
| | component | | | | |
| | (ppwb) | | | | |
| | antistatic agent | 1 | 1 | 1 | 1 |
| | (ppwb) | | | | |
| | light stabilizer | 1 | 1 | 1 | 1 |
| | (ppwb) | | | | |

Each multilayer light diffusion sheet formed in Example 1 and Comparative Examples 1-3 was evaluated for sag and optical properties. For each test, a sample having a size of 50 mm×30 mm×2 mm of each of the multilayer light diffusion sheets was prepared. One side of each sample was fixed.

The sag test was conducted as follows. A distance, i.e., height with respect to the ground, of each sample was measured with respect to a reference point. The sample was placed in an oven at 110° C. for one hour. Next, the distance, i.e., sag, of each sample was measured again with respect to the same reference point in millimeters. The difference between the two measured values, i.e., drooping of a sample in a vertical direction as a result of heat application, was reported as a sag value. The sag value is important to determine heat resistance of a polymer.

Evaluation of optical properties was conducted as follows. Each sample was subjected to UV irradiation with an ATLAS-UVCON irradiator at 60° C. for 72 hours and evaluated for variation in Yellow Index (YI), i.e., ΔYI as measured before and after UV irradiation in reference to white color coordinates according to ASTM D1925 procedures, and a smaller ΔYI value was determined as an indication of a higher light resistance. Each sample was evaluated with a hazemeter (NDH 5000W® available from Nippon Denshoku Industries Co., Ltd.) to measure optical transmittance and scatterability. Each sample was attached to a 32-inch back light, and the luminance of the back light was measured with a BM-7 luminance calorimeter to measure luminance.

The results of the sag and optical properties tests are shown in Tables 2-3, respectively.

TABLE 2
Sag Test Results

| | Ex. 1 | Com. Ex. 1 | Com. Ex. 2 | Com. Ex. 3 |
|---|---|---|---|---|
| Result | [symbol] | [symbol] | [symbol] | [symbol] |
| Sag | 1 | 10 | 6 | 13 or more |
| value | | | | |
| (mm) | | | | |

As illustrated in Table 2, the resin of Example 1, i.e., a base resin mixture including a mixture of MS and MMS, exhibited the most superior sag results, i.e., a sag value of 1 mm. In other words, the sample of Example 1 exhibited the smallest variation with respect to applied heat, thereby exhibiting superior heat resistance.

TABLE 3
Optical Tests Results

| | Ex. 1 | Com. Ex. 1 | Com. Ex. 2 | Com. Ex. 3 |
|---|---|---|---|---|
| Light | 8 | 11 | 5 | 15 |
| resistance | | | | |
| (ΔYI) | | | | |
| Optical | 51.1 | 52.0 | 62.3 | 53.2 |
| Transmittance | | | | |
| (%) | | | | |
| Optical | 93.1 | 93.0 | 92.9 | 93.1 |
| Scatterability | | | | |
| (%) | | | | |
| Luminance | 11,120 | 11,110 | 11,141 | 11,124 |
| (cd/m²) | | | | |

As illustrated in Table 3, the resin of Example 1, i.e., a base resin mixture including a mixture of MS and MMS, exhibited superior UV light resistance, as compared to Comparative Examples 1 and 3, while exhibiting light transmittance, light diffusibility and luminance values that are comparable to Comparative Examples 1 to 3.

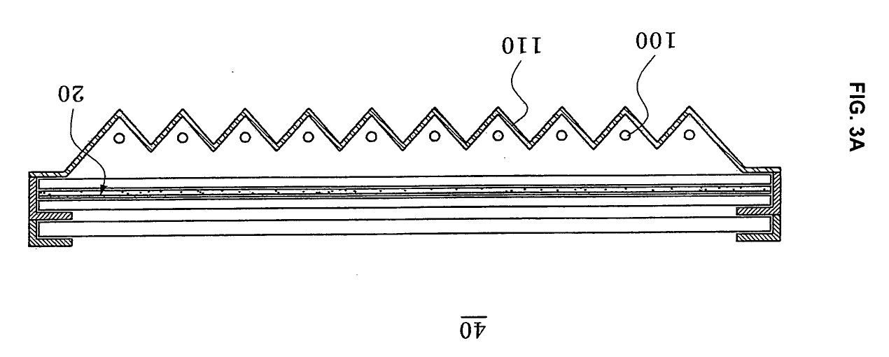

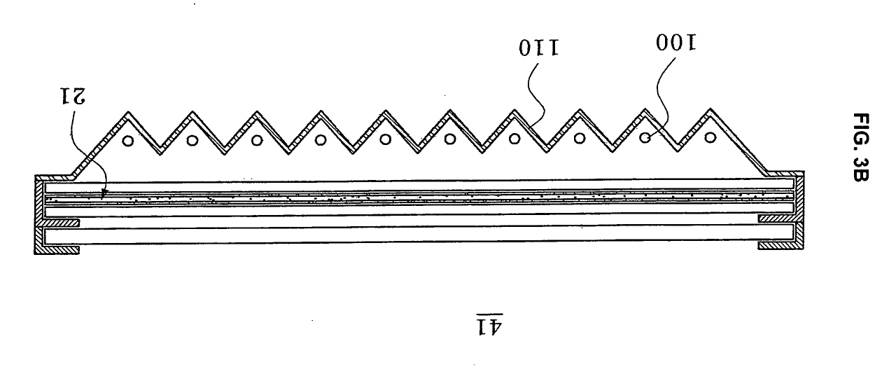

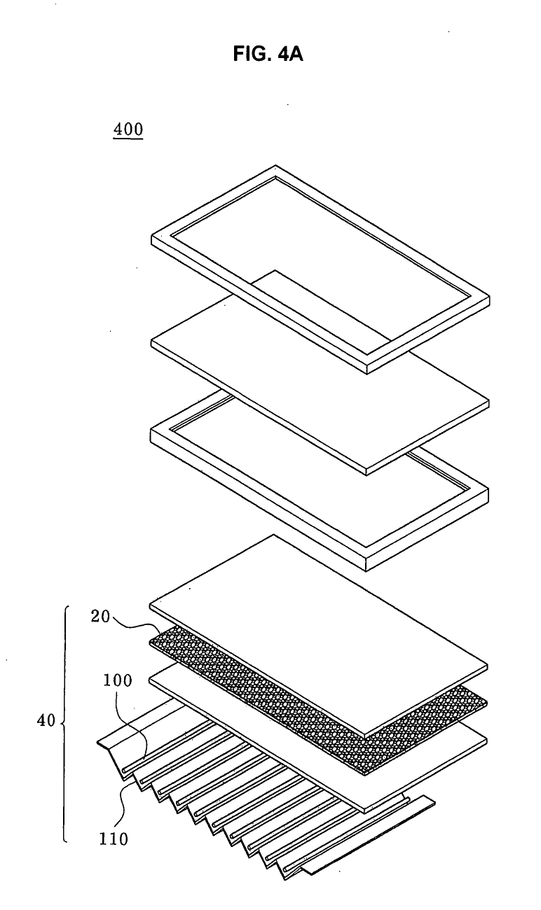

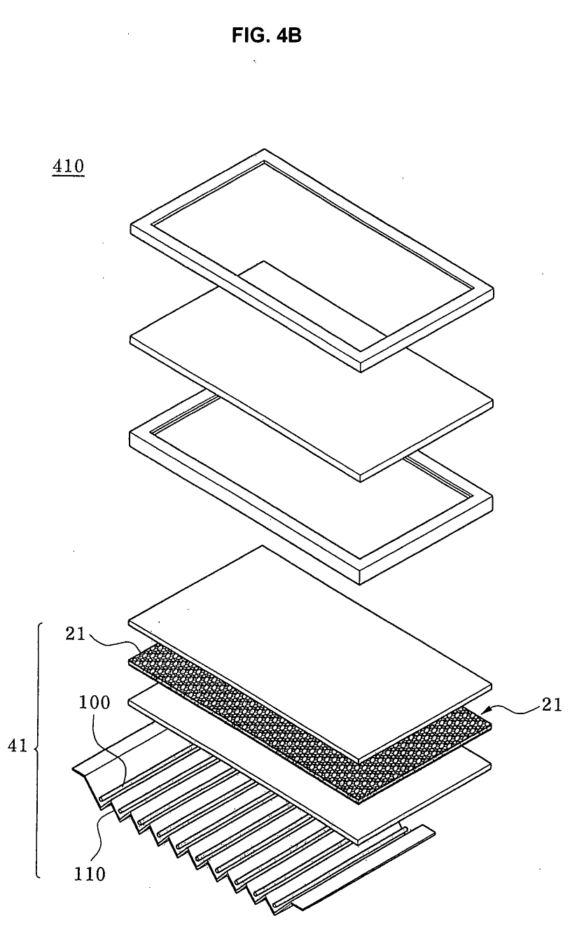

The light diffusion sheets according to embodiments of the present invention may be used in a display device, as illustrated in FIGS. 4A-4B. More specifically, as illustrated in respective FIGS. 3A-3B, a back light unit 40 or a back light unit 41 of LCD (not shown) may be constructed using suitable means, and may include at least one light source 100, a reflection sheet 110, and the light diffusion sheets 20 and 21, respectively. Accordingly, the back light units 40 and 41 may be used in LCDs 400 and 410, as illustrated in FIGS. 4A-4B, respectively.

A BLU with the light diffusion sheet according to embodiments of the present invention may have an improved optical transmittance and diffusibility due to the amorphous embossing pattern on the light diffusion sheet, thereby providing enhanced brightness. Additionally, a BLU with the light diffusion sheet according to embodiments of the present invention may exhibit an excellent light resistance and weatherability due to use of the MS/MMS resin mixture and the multi-layer structure thereof. Finally, the BLU with the light diffusion sheet according to embodiments of the present invention may further exhibit relatively low abrasion and damage of production equipment as compared to conventional BLUs.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A light diffusion sheet for a display device, comprising:
a base layer including a base resin mixture of a methacrylate-styrene copolymer and a methylmethacrylate-styrene copolymer and about 0.2 ppwb to about 20 ppwb of a first light diffuser; and
at least one coating layer on the base layer, the coating layer including a methylmethacrylate-styrene copolymer base coating resin, about 0.1 ppwb to about 30 ppwb of a second light diffuser, about 0.01 ppwb to about 2 ppwb of an UV absorber, and about 0.001 ppwb to about 10 ppwb of an antistatic agent.

2. The light diffusion sheet as claimed in claim 1, wherein the methacrylate-styrene copolymer of the base layer includes about 2% to about 20% by weight of a methacrylate monomer and about 80% to about 98% by weight of a styrene monomer.

3. The light diffusion sheet as claimed in claim 1, wherein the methylmethacrylate-styrene copolymer of the base layer includes about 6% to about 94% by weight of a methylmethacrylate monomer and about 6% to about 94% by weight of a styrene monomer.

4. The light diffusion sheet as claimed in claim 1, wherein the first light diffuser includes about 0.1 ppwb to about 10 ppwb of a siloxane component having an average diameter of about 1 μm to about 20 μm and about 0.1 ppwb to about 10 ppwb of an acrylic component having an average diameter of about 1 μm to about 20 μm.

5. The light diffusion sheet as claimed in claim 1, wherein the second light diffuser of the coating layer includes an acrylic component having an average diameter of about 1 μm to about 50 μm, a siloxane component having an average diameter of about 1 μm to about 20 μm, or a combination thereof.

6. The light diffusion sheet as claimed in claim 5, wherein the second light diffuser of the coating layer includes the siloxane component, the siloxane component including one or more of a polydimethylsiloxane, a polydiethylsiloxane, and/or a silicone resin having a three dimensional network structure.

7. The light diffusion sheet as claimed in claim 5, wherein light diffuser of the coating layer includes the acrylic component, the acrylic component including one or more of a methyl methacrylate, ethyl methacrylate, butyl methacrylate, cyclohexyl methacrylate, phenyl methacrylate, benzyl methacrylate, methyl acrylate, ethyl acrylate, butyl acrylate, cyclohexyl acrylate, phenyl acrylate and/or benzyl acrylate.

8. The light diffusion sheet as claimed in claim 1, wherein the UV absorber absorbs UV radiation of about 250 nm to about 280 nm.

9. The light diffusion sheet as claimed in claim 1, wherein the UV absorber includes one or more of a benzophenone, a benzotriazole, a cyanoacrylate, and/or a nickel complex salt.

10. The light diffusion sheet as claimed in claim 1, wherein the antistatic agent includes one or more of a polyether imide amide, a polyether ester, a polyether ester amide, a polyalkylene glycol, an alkali metal dodecylbenzene sulfonate, a tertiary amine, a quaternary ammonium, sodium chloride, and/or an alkyl amine.

11. The light diffusion sheet as claimed in claim 1, wherein the base layer has a thickness of about 100 μm to about 10,000 μm.

12. The light diffusion sheet as claimed in claim 1, wherein the coating layer has a thickness of about 10 μm to about 1,000 μm.

13. The light diffusion sheet as claimed in claim 1, wherein the coating layer includes an embossing pattern.

14. The light diffusion sheet as claimed in claim 13, wherein the embossing pattern is amorphous and has a surface roughness of about 0.1 μm to about 20 μm.

15. The light diffusion sheet as claimed in claim 1, wherein the coating layer further comprises a light stabilizer.

16. The light diffusion sheet as claimed in claim 1, wherein the light diffusion sheet includes two coating layers.

17. The light diffusion sheet as claimed in claim 16, wherein the base layer is between the two coating layers.

18. A backlight unit, comprising:
a light source;
at least one reflection sheet; and
a light diffusion sheet, the light diffusion sheet including a base layer with a base resin mixture of a methacrylate-styrene copolymer and a methylmethacrylate-styrene copolymer and about 0.2 ppwb to about 20 ppwb of a first light diffuser, and at least one coating layer on the base layer, the coating layer including a methylmethacrylate-styrene copolymer base coating resin, about 0.1 ppwb to about 30 ppwb of a second light diffuser, about 0.01 ppwb to about 2 ppwb of an UV absorber, and about 0.001 ppwb to about 10 ppwb of an antistatic agent.

19. A display device, comprising:
a display panel; and
a backlight unit with a light source, the backlight unit including a light diffusion sheet having a base layer with a resin mixture of a methacrylate-styrene copolymer and a methylmethacrylate-styrene copolymer and about 0.2 ppwb to about 20 ppwb of a first light diffuser, and at least one coating layer on the base layer, the coating layer including a methylmethacrylate-styrene copolymer base coating resin, about 0.1 ppwb to about 30 ppwb of a second light diffuser, about 0.01 ppwb to about 2 ppwb of an UV absorber, and about 0.001 ppwb to about 10 ppwb of an antistatic agent.

20. The display device as claimed in claim 19, wherein the display device is a liquid crystal display.
